(19) United States
(12) Patent Application Publication
(10) Pub. No.: US 2021/0019231 A1
(43) Pub. Date: Jan. 21, 2021

(54) METHOD, DEVICE AND COMPUTER PROGRAM PRODUCT FOR BACKING UP DATA

(71) Applicant: EMC IP Holding Company LLC, Hopkinton, MA (US)

(72) Inventors: Jingrong Zhao, Chengdu (CN); Qingxiao Zheng, Chengdu (CN)

(21) Appl. No.: 16/794,471

(22) Filed: Feb. 19, 2020

(30) Foreign Application Priority Data
Jul. 19, 2019 (CN) 201910655556.7

(51) Int. Cl. G06F 11/14; G06F 16/13

(52) U.S. Cl. CPC G06F 11/1451; G06F 2201/80; G06F 16/137

(57) ABSTRACT

Embodiments of the present disclosure provide to a method, a device and a computer program product for backing up data. The method comprises receiving a request for determining whether a data chunk is backed up and, determining a first identifier of a backup node associated with the data chunk based on a first set of the multiple sets of bits, in response to the first identifier matching the second identifier of the storage node, and determining a file identifier of an index file associated with the data chunk based on a second set of the multiple sets of bits. The method further comprises determining a location, in the index file, associated with the hash value based on a third set of the multiple sets of bits and in response to the index file storing the mapping at the location, sending an indication that the data chunk has been backed up.

### CROSS-REFERENCE TO RELATED APPLICATIONS

This application claims benefit to Chinese Patent Application 201910655556.7 filed on July 19, 2019. Chinese Patent Application 201910655556.7 is hereby incorporated by reference in its entirety.

### FIELD

Embodiments of the present disclosure generally relate to the field of data storage, and more specifically, to a method, an electronic device and a computer program for backing up data.

### BACKGROUND

With rapid development of storage technology, lots of data needs to be backed up to backup storage devices through a backup system. When the data is damaged, the data can be restored from the backup storage device through the backup system.

Current backup systems are typically multi-node backup systems. In a multi-node backup system, the data that is backup may be deduplicated. With the deduplication, data chunks are sent from a client to a server only if there is no existing copy of the data saved in any of the system's nodes. Therefore, it not only facilitates speeding up a backup/recovery process, but also reduces the cost of system resources.

### SUMMARY

Embodiments of the present disclosure provide a method, an electronic device and a computer program product for backing up data.

In accordance with the first aspect, it provides a method for backing up data in a storage node. The method comprises receiving a request for determining whether a data chunk is backed up, the request comprising a hash value associated with the data chunk, where the hash value is divided into multiple sets of bits. The method further comprises determining a first identifier of a backup node associated with the data chunk based on a first set of the multiple sets of bits. The method further comprises in response to the first identifier matching the second identifier of the storage node, determining a file identifier of an index file associated with the data chunk based on a second set of the multiple sets of bits, where the index file is used for storing a mapping between the hash value and a storage address of the data chunk. The method further comprises determining a location, in the index file, associated with the hash value based on a third set of the multiple sets of bits. The method further comprises in response to the index file storing the mapping at the location, sending an indication that the data chunk has been backed up.

In accordance with the second aspect, it provides an electronic device, the electronic device comprising a processor and a memory having computer program instructions stored thereon, the computer program instructions in the memory to control the storage node to perform actions comprising: receiving a request for determining whether a data chunk is backed up, the request comprising a hash value associated with the data chunk, the hash value being divided into multiple sets of bits; determining a first identifier of a backup node associated with the data chunk based on a first set of the multiple sets of bits; in response to the first identifier matching the second identifier of the storage node, determining a file identifier of an index file associated with the data chunk based on a second set of the multiple sets of bits, the index file being used for storing a mapping between the hash value and a storage address of the data chunk; determining a location, in the index file, associated with the hash value based on a third set of the multiple sets of bits; and in response to the index file storing the mapping at the location, sending an indication that the data chunk has been backed up.

In accordance with the third aspect, it provides a computer program product tangibly stored on a non-transitory computer readable medium and comprising machine executable instructions that, when executed, cause the machine to perform the steps of the method of the first aspect of the present disclosure.

### BRIEF DESCRIPTION OF THE DRAWINGS

Through the following detailed description with reference to the accompanying drawings, the above and other objectives, features, and advantages of example embodiments of the present disclosure will become more apparent. In the exemplary embodiments of the present disclosure, the same reference numerals generally denote the same components.

FIG. 1 is a schematic diagram illustrating an example environment 100 in which a device and/or method described herein can be implemented in accordance with an embodiment of the present disclosure;

FIG. 2 is a flow diagram illustrating a method 200 of backing up data chunks in accordance with an embodiment of the present disclosure;

FIG. 3 is a flow diagram illustrating a hash value 300 in accordance with an embodiment of the present disclosure;

FIG. 4 is a flow diagram illustrating a method 400 of backing up data chunks in accordance with an embodiment of the present disclosure; and

FIG. 5 is a schematic block diagram illustrating an example device 500 adapted to implement embodiments of the present disclosure.

In the various figures, the same or corresponding reference numerals indicate the same or corresponding parts.

### DETAILED DESCRIPTION OF EMBODIMENTS

Principles of example embodiments disclosed herein will now be described with reference to various example embodiments illustrated in the drawings. It should be appreciated that description of those embodiments is merely to enable those skilled in the art to better understand and further implement example embodiments disclosed herein and is not intended for limiting the scope disclosed herein in any manner.

In the description of the embodiments of the present disclosure, the term “includes” and its variants are to be read as open-ended terms that mean “includes, but is not limited to.” The term “based on” is to be read as “based at least in part on.” The term “one embodiment” or “the embodiment” is to be read as “at least one embodiment.” The terms “first”, “second” and the like may refer to different or identical objects. Other explicit and implicit definitions may also be included below.

Principles of the present disclosure will be described below with reference to a few exemplary embodiments illustrated in the drawings. Although the preferred embodiment of the present invention has been shown in the drawings, it is understood that the embodiments of the present invention are intended to be understood by those skilled in the art but not to limit the scope of the present disclosure.

In a hash-based multi-node backup system, for each hash value of each data block there is a unique slot in a certain index file of a certain storage node, and the position of corresponding data chunk is saved in this slot. Thus, knowing the slot location of hash value equals to knowing the storage address of data chunk.

In a hash-based multi-node backup system, when backing up a data chunk, a client may first query its locally validated cache file for its hash value. If the hash value is not present, the client first connects to a router node with a unique entry IP (the router node may also be configured to operate by one of storage nodes) to obtain the most suitable storage node connection based on a node selection algorithm. The client may then send a request message including the hash value to a connected storage node obtained from the router node. On the storage node, it will first run an AND operation on the first N bytes of hash value and a match bits filter, and get an index file location through searching a disk file, where the disk file stores a mapping relationship between an AND operation result of the hash value and a matching filter (predetermined value) and the index file. If the target index file is not in the locally connected storage node, a message including hash is redirected to a target node. The storage node where the target index file is located will check whether the hash value is present in the index file and return a hit or miss back to the client. According to the returned result, the data represented by the hash value will be sent by the client to the server. This can ensure that one piece of data is saved only once in one storage node.

During a backup process, the global deduplication in the hash-based multi-node backup system uses Nodelndex and Filelndex for hash, where Slotlndex identifies the index of the slot in the index file and Filelndex identifies the index file and Filelndex uses the disk file to record the mapping between the hash value and the index file. This disk file needs to be synchronized and consistent between each storage node. The “Nodelndex-Filelndex” in the position of the hash value may be obtained performing a logical AND operation on the first N bytes of the hash and the matching bit filter (for example, a set predetermined value). As the data in the backup system increases, the content of the disk file increases, and a matching bit filter is also added to differentiate more index files accordingly.

Although this method achieved the global deduplication with accurate checking result and no message broadcast, it still has some defects. Considering the dramatically increasing of the amount of data chunks in a real backup system, both match bits filter and disk file need to be increased accordingly to support this feature. For example, each record in the mapping file will be 6 bytes, which includes at least 2 bytes for node index and 4 bytes for file index. Thus, space occupied by this disk file may be at the megabyte of gigabyte level. Moreover, frequent reading from and writing to the disk file is time consuming with low efficiency. Furthermore, there are also various problems in terms of guarantee of file synchronization and consistency between all the storage nodes all the time, because it will cause system risks and an increase of maintenance work amount as well.

In order to solve one or more of the above problems, the present disclosure proposes a scheme for backing up data. According to various embodiments of the present disclosure, a hash value of data chunk is divided into multiple sets of bits, and then a storage node storing the hash value is determined by the first set of the multiple sets of bits; an index file storing the hash value is determined by the second set of the multiple sets of bits and a storage location, in the index file, associated with the hash value is determined by the third set of the multiple sets of bits. In the above manner, the storage location of the hash value can be quickly determined without storing, at each storage node, a mapping relationship between an AND operation result of the hash value and a matching filter (predetermined value) and the index file, thereby reducing a data reading process and it is easy to keep synchronization and consistency between storage nodes.

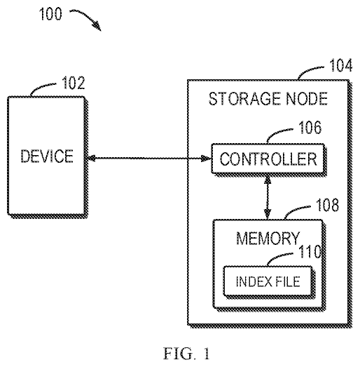

FIG. 1 is a diagram illustrating an example environment 100 in which a device and/or method described herein can be implemented in accordance with embodiments of the present disclosure.

As shown in FIG. 1, the example environment 100 includes a device 102 and a storage node 104. Alternatively or additionally, the device 102 and the storage node 104 in the example environment 100 are for example only, rather than specific limitation to the scope of the disclosure. Any number of devices and storage nodes capable of communicating with one another may be included in the example environment 100.

The device 102 is configured to send, to the storage node 104, a request for determining whether a data chunk is backed up and the request includes a hash value of the data chunk. Device 102 may be implemented as any type of computing device including, but not limited to, a server, a mobile phone (e.g., a smartphone), a laptop computer, a portable digital assistant (PDA), an e-book (e-book) reader, a portable game machine, a portable media player, a game console, a set-top box (STB), a smart television (TV), a personal computer, a laptop computer, an on-board computer (e.g., a navigation unit), and the like.

In some embodiments, the device 102 is a client. When the client backs up the data chunk, it generates a hash value for the data chunk. This hash value uniquely identifies the data chunk. Alternatively or additionally, the client typically first looks up within the hash value of the valid backed up data chunk it stores. When the hash value is not present in the client, the client sends a request to the storage node 104 to query whether the data chunk has been backed up, where the request includes a hash value of the data chunk.

In some embodiments, the client may need to determine to which storage node it sent the request through a routing server. Typically, the client sends a request to the routing server whose address is known to query which storage node is needed to determine if the data chunk has been backed up. The routing server may determine, based on a certain policy, which storage node in the multi-node backup system is available to process the request sent by the client. In one example, the policy may be to determine a storage node based on the amount of load of storage node storage, e.g., a storage node with the least amount of load. In one example, the policy may be to select a storage node by polling the storage node. Then, the router server sends the address of the selected storage node to the client, and then the client connects to the storage node through the obtained address of the storage node. Alternatively or additionally, the routing server may also be a storage node. The above examples are only intended to describe the disclosure, and are not intended to limit the scope of the disclosure. The client 102 may connect to storage node 104 in any suitable manner.

In some embodiments, the device 102 may be another storage node. The other storage node sends a request to the storage node 104 including a hash value to determine if the data chunk is backed up on the storage node 104.

The storage node 104 is a device that stores data chunks. The storage node 104 may be implemented as, but not limited to, a server, a personal computer, a laptop computer, an onboard computer, and the like. The storage node 104 includes a controller 106 and a memory 108.

The controller 106 is used to control the backup of the data chunk and check whether the data chunk is backed up. The controller 106 may include a software module or a hardware processor. The hardware processing includes but not limited to a hardware central processing unit (CPU), a field programmable gate array (FPGA), a composite programmable logic device (CPLD), an application specific integrated circuit (ASIC), a system on chip (SoC), or a combination thereof.

The controller 106 may determine whether the data chunk has been backed up based on the hash value of the data chunk received from the client 102. The controller 106 divides the received hash values into at least three sets of bits, and the first set of bits is used to determine a storage node for storing data chunks or hash values. If it is determined from the first set of bits that the storage node of the data chunk is another storage node, the storage node 104 sends a request including a hash value to the other determined storage nodes to determine whether the data chunk is stored on the determined other storage node.

If it is determined from the first set of bits that the data chunk is to be backed up in the storage node 104, the controller 106 checks the second set of bits in the hash value to determine an index file 110 for storing the hash value, and determines the location of the hash value in the index file 110 based on third set of bits. If there is data stored at this location, an indication that the data chunk has been backed up is returned to the device 102. If there is no data stored at this location, it means that the data chunk has not been backed up. At this point, the storage node 104 sends a response to the device 102 to indicate that the data chunk was not stored on the storage node 104. Then, the storage node 104 receives the data chunks from the client and stores them in the storage device of the storage node 104. After the storage of the data chunk is completed, the storage address of the data chunk is stored in association with the hash value in the index file 110.

The index file 110 is stored in the memory 108. If the data chunk is already stored in the storage node 104, the mapping relationship formed between the hash value of the data chunk and the storage location of the data chunk in the storage node 104 is stored in the index file 110. Therefore, whether or not the data chunk has been backed up may be determined by determining whether or not the location corresponding to the hash value of the data chunk is stored with data in the index file 110.

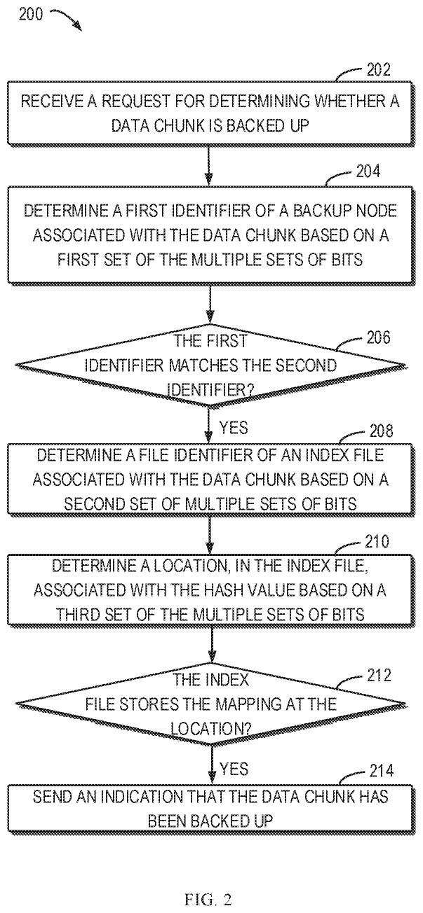

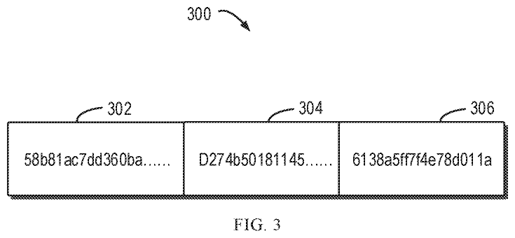

The schematic diagram of the example environment 100 in which devices and/or methods can be implemented in accordance with embodiments of the present disclosure is described above in connection with FIG. 1. A process of data backup is described below in conjunction with FIGS. 2 and 3, where FIG. 2 is a flow diagram illustrating a method 200 of backing up data chunks in accordance with an embodiment of the present disclosure; FIG. 3 is a flow diagram illustrating a hash value 300 in accordance with an embodiment of the present disclosure.

As shown in FIG. 2, at block 202, a storage node receives a request for determining if the data chunk is backed up, where the request includes a hash value associated with the data chunk and the hash value is divided into multiple sets of bits. For example, the storage node 104 in FIG. 1 receives, from device 102, a request for determining if a data chunk is backed up, where the request includes a hash value associated with the data chunk to be backed up.

In some embodiments, the number of bits in each of the multiple sets of bits may be set to any suitable length based on needs. For example, the number of first set of bits, the number of second set of bits, and the number of third set of bits may be set separately to any suitable size upon needs.

In some embodiments, the number of each set of bits in multiple sets of bits is an integer multiple of the number of bytes. For example, the first set of bits includes 1 byte, i.e., 8 bits. The second set of bits includes 4 bytes, i.e., 32 bits. The third set of bits includes 8 bytes, i.e., 64 bits.

As shown in FIG. 3, the hash value 300 is expressed in hexadecimal, and each bit corresponds to four bits. The hash value 300 may be divided into a first set of bits 302, a second set of bits 304, and a third set of bits 306.

Returning back to FIG. 2, at the block 204, the storage node determines a first identifier of the backup node associated with the data chunk based on the first set of the multiple sets of bits. For example, the storage node 104 in FIG. 1 determines an identity associated with a backup node of a data chunk based on a first set of the multiple sets of bits. The process of determining the first identifier will be described later.

At block 206, the storage node determines whether the first identifier matches the second identity of the storage node. For example, the storage node 104 in FIG. 1 determines whether the first identifier determined by the first set of bytes of the hash value matches the second identifier of storage node 104. The process of determining match of the two identifiers is a process of determining if the hash value is located at storage node 104.

When the first identifier does not match the second identifier, the storage node sends, to the backup node, a request for determining whether a data chunk has been backed up in the backup node. Whether the data chunk has been backed up in the backup node is determined with this request, where the request includes a hash value associated with the data chunk.

When the first identifier matches the second identifier, at block 208, the storage node determines, based on the second set of the multiple sets of bits, a file identifier of the index file associated with the data chunk, where the index file is used to store a mapping between the hash value and the storage address of the data chunk. For example, the storage node 104 in FIG. 1 may determine, based on a second set of the multiple sets of bits, an identifier of index file 110 for storing hash values. The process of determining the file identifier will be described later.

At block 210, the storage node determines, based on the third set of the multiple sets of bits, a location in the index file associated with the hash value. For example, the storage node 104 in FIG. 1 may determine, based on the third set of the multiple sets of bits, a location in index file 110 associated with a hash value. This location may be used to store a mapping between the hash value and the storage address of the data chunk. The process for determining the location will be further described in the following description.

At block 212, the storage node determines if the index file stores a mapping at this location. Upon determining that the index file stores a hash-related mapping at the location, at block 214, the storage node sends an indication that the data chunk has been backed up. For example, in FIG. 1, when the storage node 104 determines that a hash value stores data in index file 110, the storage node 104 sends an indication, to device 102, that the data chunk has been backed up.

With the above method, whether a data chunk is backed up is quickly determined by detecting multiple sets of bit of the hash value, thereby reducing unnecessary disk read and without a disk file storing a mapping relationship between an AND operation result of the hash value and match filter and the index file, thereby improving system performance and saving storage space. In addition, this approach also decouples the storage nodes and does not require synchronization, thus avoiding inconsistent risks.

A storage node determines, based on a first set of the multiple sets of bits, a first identifier of a backup node associated with a data chunk is described in the block 204 of the above FIG. 2. Some embodiments will be described below. The following embodiments are only for describing the present disclosure, and are not limiting of the present disclosure, and any suitable manner may be employed to determine the first identifier of the backup node based on the first set of the multiple sets of bits.

In some embodiments, the storage node determines the first identifier based on the first set of bits and a first predetermined value, where the first predetermined value is determined based on the number of storage nodes in the backup system. If the number of storage nodes in the multiple-node backup system is N, the first predetermined value NMBF may be determined by the following formula (1):

$$\{ \begin{matrix}{2}^{m} >= N , m ∈ A ; \\ NMBF = {2}^{n} - 1 , n = min ( A ) ;\end{matrix} \qquad ( 1 )$$

In the formula, m represents an integer greater than or equal to 0, A represents a set of all m satisfying 2^{m}>=N, and n represents the smallest integer in set A. Once an initial configuration in the multi-node backup system is completed, the first predetermined value NMBF becomes a static value.

A backup node storing the hash value is determined through a logic AND operation on a binary string representing the first predetermined value NMBF and a binary string representing the first set of bits, which is shown in the following equation:

Nodelndex=C & NMBF (2)

Where Nodelndex represents indication information associated with the backup node, and C represents the first set of bits. Therefore, the storage node for storing the hash value can be determined by the determined Nodelndex.

In some embodiments, when the number of storage nodes does not equal equals to 2^{m}(m>0), there may be some Nodelndexs which do not correspond to any backup nodes. For example, there are three storage nodes in a backup system with, then the first predetermined value NMBF is 0b 11. Where
NodeIndex==0b00 means the storage node is storage node 0;
NodeIndex==0b01 means the storage node is storage node 1;
NodeIndex==0b10 means the storage node is storage node 2;

However, when NodeIndex==0b11, there is no storage node matching with it. Alternatively or additionally, in order to make the distribution of index file even among various storage nodes, the bits of the first predetermined value may be doubled to expand the bits of the first predetermined value for the case where NodeIndex 0b11 is 11. Thus, there will be below additional matching pairs:

NodeIndex==0b0011 means the storage node is storage node 0;

NodeIndex==0b0111 means the storage node is storage node 1;

NodeIndex==0b1011 means the storage node is storage node 2.

This method of expanding the first predetermined value by increasing the bit can be expanded as many times as necessary. Alternatively or additionally, for a NodeIndex that cannot be distinguished by spreading bits, the mapping relationship may be pre-determined, for example, mapped to a predetermined storage node. In some embodiments, if a new storage node is added, the mapping relationship may be recalculated for all hash values and the corresponding data chunks may be migrated to the new storage node.

By adopting the above method, the storage node associated with the hash value can be quickly determined, thereby improving the efficiency of data processing. This method also facilitates the expansion of the system and supports dynamic expansion of system configurations, such as adding new storage nodes.

In the description of block 208 above, the storage node determines a file identifier of an index file associated with the data chunk based on the second set of the multiple sets of bits, where the index file is used to store mapping between the hash value and the storage address of the data chunk. Description will be made below in conjunction with some embodiments. The following embodiments are only for describing the present disclosure, rather than limiting the scope of the present disclosure, and the file identifier of an index file associated with a data chunk may be determined based on a second set of multiple sets of bits in any suitable manner.

In some embodiments, the file identifier is determined based on the second set of the multiple sets of bits and the second predetermined value, where the second predetermined value is determined based on the number of index files in the storage node.

If the number of index files in the storage node is M, the second predetermined value FMBF may be determined by the following equation (3):

$$\{ \begin{matrix}{2}^{m} >= M , m ∈ A ; \\ FMBF = {2}^{n} - 1 , n = min ( A ) ;\end{matrix} \qquad ( 3 )$$

Where m represents an integer greater than or equal to 0, A represents a set of all m satisfying 2^{m}>=M, and n represents the smallest integer in set A.

In some embodiments, an identifier of the index file storing hash value is determined through a logic AND operation on a binary string representing the second predetermined value FMBF and a binary string representing the second set of bits. Filelndex associated with the identifier of index file is determined with the following equation (4):

Filelndex=F & FMBF (4)

where F represents the second set of bits.

In some embodiments, if there are only two index files in a storage node at the beginning, so it is enough to set FMBF as 0b01. Then:

F & 0b 01==0b00 means the hash value resides in the first index file 00000000.index;

F & 0b 01==0b01 means the hash value resides in the second index file 00000001.index.

Alternatively or additionally, if the size of the first index file 00000000.index exceeds the maximum limit, the first index file 00000000.index will be divided into a new first index file 00000000.index and a newly created third index file 00000010.index. The third index file 00000010.index is on the same storage node as the first index file 00000000.index, and the second predetermined value FMBF is adjusted by:

FMBF=FMBF<<1+1 (5)

This means shifting the FMBF of the binary representation to the left by one bit and then adding one. Now, it becomes that:

F & 0b11==0b00 means the hash value resides in the first index file 00000000.index

F & 0b11==0b10 means the hash value resides in the third index file 00000010.index

F & 0b11==0b01 means the hash value resides in the second index file 00000001.index

F & 0b11==0b11 means the hash value resides in the fourth index file 00000011.index

However, the fourth index file 00000011.index is not present at this time. Therefore, when there is a mapping to the fourth index file 00000011.index that does not exist, the adjusted second predetermined value is decremented by one, and then shifted to the right by one bit i.e., turning to the state before adjustment of the second predetermined value, and then an AND operation on the second set of bits and the second predetermined value before adjustment is performed to determine the index file in which the hash value is located.

Through the above method for determining an index file, the index file where the hash value is located can be quickly found, and the number of index files can be dynamically adjusted, thereby improving the efficiency and flexibility of processing.

The storage node determining, based on the third set of the multiple sets of bits, a location in the index file that is associated with the hash value is described above at block 210. Some embodiments will be described below. The following embodiments are only for describing the present disclosure, rather than limiting the scope of the present disclosure, and any suitable manner may be employed to determine a location in the index file associated with a hash value based on a third set of the multiple sets of bits.

In some embodiments, the third set of bits is first converted when determining a location in the index file that is associated with the hash value.

In some embodiments, an 8-byte value is converted to a double precision number when, for example, the third set of bits includes 8 bytes. The double-precision value corresponding to the converted 8 bytes ranges between 0-1. The storage location of the hash value is then determined by multiplying the value of the converted third set of bits and the number of entries in the index file that are available for storing the mapping.

In one example, when the third set of bits is 8 bytes, the process of converting to a double-precision number is as follows:

First, the following conversion is performed: unsigned char*bytes[7]=(char *) &D, where D is the third set of bits, 8 bytes, and a total of 64 bits. The bytes stored in the computer is a little endian storage, such as a double precision number, which is stored in the computer memory as 0x46438a5237f4e0ad, occupying 8 bytes, and its byte address is increased from low to high. However, when it is converted to a double precision, the value is 0xade0f437528a4346, which is read from a high address.

Then an operation bytes[7]=0×3F and bytes[6]|=0×F0 is performed, which means setting the first 12 bits of the 64-bit bit value. This operation sets the sign bit to 0, indicating that this double-precision number is a positive number. The 11 bits following the sign bit are an exponent value, which is the value of n in the binary scientific notation 2″. The size that 11 bits can represent is 0 to 2¹¹−1 (2047). Here, the last 10 bits of the exponent bit are set to 1, then the value of the exponent bit is 1023 (2¹⁰−1). The value of the exponent bit is then subtracted by an offset value of 1023, and the value of the exponent bit is zero. The last 52 bits in 64 are a mantissa. The resulting double-precision number is 1.xxxxx×2⁰=1.xxxxxx. Then, the value of the converted third set of bits is performed as follows: D=D−1.

Then determining the location Slotlndex of the hash value in the index file by the following formula: Slotlndex=(int) (D * M), where D represents the converted double precision, and M represents the storable maximum number of hash values, in the index file, that is associated with the data chunks.

With the above method, the storage location of the hash value in the index file can be quickly determined, and after the third set of bits is converted into a double precision number, less hash conflict will be caused for the address of the hash value of the index file.

Furthermore, when there is hash conflict at the location determined by the above manner, a conventional scheme for solving the hash conflict, such as an open hash, a bucket hash, and the like, may be used to solve it.

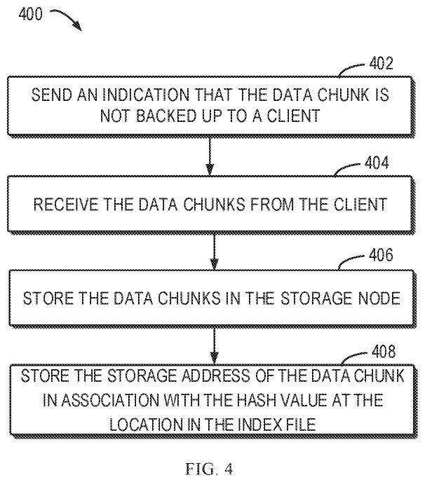

The operation of the index file having a mapping at the determined location is described above in connection with block 214 of FIG. 2, and the operation of the index file having no mapping at the determined location is described below with reference to FIG. 4. FIG. 4 is a flow diagram illustrating a method 400 of backing up data chunks in accordance with an embodiment of the present disclosure.

As shown in FIG. 4, the storage node determines that the index file does not have a mapping stored at the location, and at block 402, the storage node sends an indication that the data chunk is not backed up. In one example, the storage node received a request from a client, and the storage node sends the indication to the client. In another example, the storage node received a request from another storage node, and the storage node sends an indication to another storage node.

At block 404, the storage node receives the data chunk. When a storage node sends to a client or another storage node that a data chunk is not backed up on the storage node, it indicates that the data chunk on the client is not backed up. Therefore, the client sends the data chunk to be backed up. At this point, the storage node receives the data chunk from the client.

At block 406, the storage node stores the data chunk in the storage node. After the storage node receives the data chunk, the storage node stores the data chunk in a storage device associated with the storage node. The storage address of the data chunk in the storage device can then be determined.

At block 408, the storage node stores the storage address of the data chunk in association with the hash value at the location in the index file. The storage location in the index file for storing the mapping between the storage address and the hash value is determined based on a third set of bits of the hash value, where the index file is determined based on the second set of bits of the hash value.

Storing the data chunk with the above method, the data redundancy in the storage device can be reduced, and the storage resource of the storage node can be utilized more effectively, thereby improving the resource utilization rate.

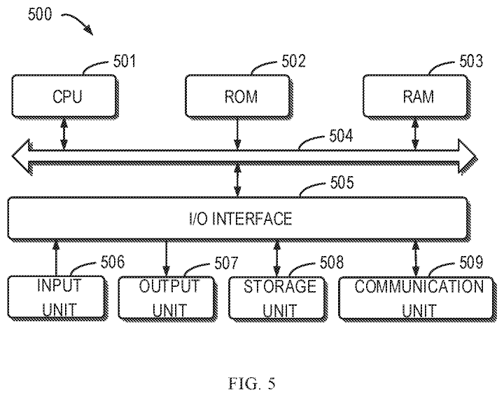

FIG. 5 is a block diagram illustrating a device 500 adapted to implement embodiments of the present disclosure. For example, any of 102, 104 as shown in FIG. 1 can be implemented by device 500. As shown in FIG. 5, the device 500 includes a central processing unit (CPU) 501 that may perform various appropriate actions and processing based on computer program instructions stored in a read-only memory (ROM) 502 or computer program instructions loaded from a storage section 508 to a random access memory (RAM) 503. In the RAM 503, there further store various programs and data needed for operations of the device 500. The CPU 501, ROM 502 and RAM 503 are connected to each other via a bus 504. An input/output (I/O) interface505 is also connected to the bus 504.

The following components in the device 500 are connected to the I/O interface 505: an input 506 such as a keyboard, a mouse and the like; an output unit 507 including various kinds of displays and a loudspeaker, etc.; a memory unit 508 including a magnetic disk, an optical disk, and etc.; a communication unit 509 including a network card, a modem, and a wireless communication transceiver, etc. The communication unit 509 allows the device 500 to exchange information/data with other devices through a computer network such as the Internet and/or various kinds of telecommunications networks.

Various processes and processing described above, e.g., the method 200 or 400, may be executed by the processing unit 501. For example, in some embodiments, the method 200 or 400 may be implemented as a computer software program that is tangibly embodied on a machine readable medium, e.g., the storage unit 508. In some embodiments, part or all of the computer programs may be loaded and/or mounted onto the device 500 via the ROM 502 and/or the communication unit 509. When the computer program is loaded to the RAM 503 and executed by the CPU 501, one or more steps of the method 200 or 400 as described above may be executed.

The present disclosure may be a system, an apparatus, a device, a method, and/or a computer program product. The computer program product may include a computer readable storage medium (or media) having computer readable program instructions thereon for causing a processor to carry out aspects of the present disclosure.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a flash medium SSD, a PCM SSD, a 3D Xpoint, a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, an electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, devices (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, snippet, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reversed order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of backing up data in a storage node, comprising:
receiving a request for determining whether a data chunk is backed up, the request comprising a hash value associated with the data chunk, the hash value comprising bits;
determining a first identifier of a backup node associated with the data chunk based on a first set of the bits;
in response to the first identifier matching a second identifier of the storage node, determining a file identifier of an index file associated with the data chunk based on a second set of the bits, the index file specifying a mapping between the hash value and a storage address of the data chunk;
determining a location, in the index file, associated with the hash value based on a third set of the bits; and
in response to the index file storing the mapping at the location, sending an indication that the data chunk has been backed up.

2. The method of claim 1, further comprising:
in response to the index file not storing the mapping at the location, sending an indication that the data chunk is not backed up; and
receiving the data chunk to back up the data chunk.

3. The method of claim 2, wherein receiving the data chunk to back up comprises:
receiving the data chunk;
storing the data chunk in the storage node; and
storing the storage address of the data chunk in association with the hash value at the location in the index file, wherein the location in the index file is determined based on the third set of bits, wherein the index file is determined based on the second set of the bits.

4. The method of claim 1, further comprising:
in response to the first identifier not matching the second identifier, sending, to the backup node, a request comprising the hash value.

5. The method of claim 1, wherein determining the first identifier of the backup node associated with the data chunk comprises:
determining the first identifier based on the first set of the bits and a first predetermined value, the first predetermined value being determined based on a number of storage nodes in a backup system.

6. The method of claim 5, wherein determining the first identifier comprises:
determining the first identifier by a logic AND operation on a first binary string representing the first set of the bits and a second binary string representing the first predetermined value.

7. The method of claim 1, wherein determining a file identifier of an index file associated with the data chunk comprises:
determining the file identifier based on the second set of the bits and a second predetermined value, the second predetermined value being determined based on a number of index files in the storage node.

8. The method of claim 7, wherein determining the file identifier comprises:
determining the file identifier by a logic AND operation on a third binary string representing the second set of the bits and a forth binary string representing the second predetermined value.

9. The method of claim 1, wherein determining the location, in the index file, associated with the hash value comprises:
converting the third set of the bits; and
determining the location based on the converted value of the third set of the bits and a number of entries in the index file that are available to store mapping.

10. An electronic device comprising:
a processor; and
a memory having computer program instructions stored thereon, the processor executing the computer program instructions in the memory to control the electronic device to perform a method, the method comprising:
receiving a request for determining whether a data chunk is backed up, the request comprising a hash value associated with the data chunk, the hash value comprising bits;
determining a first identifier of a backup node associated with the data chunk based on a first set of the bits;
in response to the first identifier matching a second identifier of a storage node, determining a file identifier of an index file associated with the data chunk based on a second set of the bits, the index file specifying a mapping between the hash value and a storage address of the data chunk;
determining a location, in the index file, associated with the hash value based on a third set of the bits; and
in response to the index file storing the mapping at the location, sending an indication that the data chunk has been backed up.

11. The electronic device of claim 10, the method further comprising:
in response to the index file not storing the mapping at the location, sending an indication that the data chunk is not backed up; and
receiving the data chunk to back up the data chunk.

12. The electronic device of claim 11, wherein receiving the data chunk to back up chunk comprises:
receiving the data chunk;
storing the data chunk in the storage node; and
storing the storage address of the data chunk in association with the hash value at the location in the index file, wherein the location in the index file is determined based on the third set of the bits, wherein the index file is determined based on the second set of the bits.

13. The electronic device of claim 10, the method further comprising:
in response to the first identifier not matching the second identifier, sending, to the backup node, a request comprising the hash value.

14. The electronic device of claim 10, wherein determining the first identifier of the backup node associated with the data chunk comprises:
determining the first identifier based on the first set of the bits and a first predetermined value, the first predetermined value being determined based on a number of storage nodes in a backup system

15. The electronic device of claim 14, wherein determining the first identifier comprises:
determining the first identifier by a logic AND operation on a first binary string representing the first set of bits and a second binary string representing the first predetermined value.

16. The electronic device of claim 10, wherein determining a file identifier of an index file associated with the data chunk comprises:
determining the file identifier based on the second set of the bits and a second predetermined value, the second predetermined value being determined based on a number of index files in the storage node.

17. The electronic device of claim 16, wherein determining the file identifier comprises:
determining the file identifier by a logic AND operation on a third binary string representing the second set of the bits and a forth binary string representing the second predetermined value.

18. The electronic device of claim 10, wherein determining the location, in the index file, associated with the hash value comprises:
converting the third set of the bits; and
determining the location based on the converted value of the third set of the bits and a number of entries in the index file that are available to store mapping.

19. A computer program product being tangibly stored on a non-transitory computer-readable medium and comprising machine executable instructions that, when executed, cause a machine to perform a method, the method comprising.
receiving a request for determining whether a data chunk is backed up, the request comprising a hash value associated with the data chunk, the hash value comprising bits;
determining a first identifier of a backup node associated with the data chunk based on a first set of the bits;
in response to the first identifier matching a second identifier of a storage node, determining a file identifier of an index file associated with the data chunk based on a second set of the bits, the index file specifying a mapping between the hash value and a storage address of the data chunk;
determining a location, in the index file, associated with the hash value based on a third set of the bits; and
in response to the index file storing the mapping at the location, sending an indication that the data chunk has been backed up.

20. The computer program product of claim 19, wherein the method further comprises:
in response to the index file not storing the mapping at the location, sending an indication that the data chunk is not backed up; and
receiving the data chunk to back up the data chunk.
